(19) United States
(12) Patent Application Publication
(10) Pub. No.: US 2014/0356118 A1
(43) Pub. Date: Dec. 4, 2014

(54) HANDICAP VEHICLE LIFT APPARATUS

(71) Applicant: West Coast Customs, Corona, CA (US)

(72) Inventors: Ryan FRIEDLINGHAUS, Corona, CA (US); Kenneth Karl PFITZER, Corona, CA (US); Patrick Louie DIETZ, Manhattan Beach, CA (US); Jeffrey Daniels BRUEGGEMAN, Trabuco Canyon, CA (US)

(73) Assignee: WEST COAST CUSTOMS, Corona, CA (US)

(21) Appl. No.: 14/294,760

(22) Filed: Jun. 3, 2014

Related U.S. Application Data
(60) Provisional application No. 61/830,393, filed on Jun. 3, 2013.

(51) Int. Cl. A61G 3/06

(52) U.S. Cl. CPC A61G 3/061
USPC 414/523

(57) ABSTRACT

A wheelchair lift apparatus for a vehicle including a primary frame, an extendable base, and a wheelchair platform which can is capable of transferring a wheelchair and wheelchair user into and out of a vehicle and is suitable for use during operation of the vehicle.

### FIELD OF THE INVENTION

The invention is directed to a lift apparatus for lifting a person in a wheel chair into a vehicle, securing a person in a wheel chair to a vehicle while in operation, and returning a person in a wheel chair which is also in a vehicle to the ground.

### SUMMARY OF THE INVENTION

The apparatus of the current invention includes a primary frame, an extendable base, and a wheelchair platform. The primary frame attaches the extendable base and wheelchair platform to a vehicle. The extendable base is attached to the primary frame by way of first track mechanism. The wheelchair platform is attached to the extendable base by way of a second track mechanism that is optionally the same or different from the first track mechanism. In some embodiments, the extendable base is attached directly to a vehicle frame and the primary frame is not used.

In the preferred embodiment, the primary frame includes a front side member, a back side member, a door side member, and an interior side member. In the preferred embodiments, the primary frame is rectangular or square. In some embodiments, part of a vehicle frame is removed and replaced by the primary frame.

In the preferred embodiment, the front and back side members are larger than the door side and interior side members. In some embodiments, only the front and back side members are attached to the frame and the door side and interior side members are attached only to the front and back side members. In some embodiments, all side members are attached to the vehicle.

In the preferred embodiments, the door side and interior side members are attached to the bottom portion of the front and back side members, i.e., the bottom of the door side and interior side members are flush or nearly flush with the bottom of the front and back side members. In the preferred embodiments, the door side member is of a height which allows the top surface of the wheelchair platform to be flush or nearly flush to the top of the front and back side members when in a fully retracted position.

In the preferred embodiments, the primary frame includes a center member that is attached to the front and back members and optionally to a vehicle frame. The center member is positioned between the door side and interior side members. In the preferred embodiments, the center member is positioned adjacent to the interior side track member of the extendable base. In the preferred embodiments, the center member is larger than any of the side members.

In the preferred embodiments, the motors which power the extendable members of the extendable base are attached to the interior side member of the primary base.

In the preferred embodiments, the front and back members include track members and function as compatible female coupling members to wheels or bearings of the extendable base that function as compatible male coupling members. When the motors attached to the interior side members push or pull on the extendable base the extendable base moves along the track members of the primary frame.

In some embodiments, each member is made of multiple smaller member section, however, for the purposes of this application the collection of smaller members that make up a front, back, door side, or interior side of the frame are considered together to be a member. In some embodiments, the members are straight. In some embodiments, the members are curved or are comprised of abrupt changes in direction. In some embodiments, the members are attached to each other at positions other than the terminal ends.

The extendable base includes at least one extendable front side member and at least one extendable backside member. The extendable members are positioned parallel to each other. The extendable base also includes a non-extendable door side member which is attached at its terminal ends or optionally near its terminal ends to the door side terminal ends, or optionally near the door side terminal ends of the extendable members.

In some embodiments, the extendable base also includes a non-extendable interior side member. In some embodiments, the terminal ends of the extendable members on the interior side are attached directly to the frame of the vehicle, for example, by welding or with fasteners.

All extendable and non-extendable members are made of rigid material, for example, metal.

In the preferred embodiment, the extendable members have bearings or wheels mounted to their exterior sides which function as male track coupling members and interact with the track members of the primary frame or with track members which are attached to the body of a vehicle where the track member acts as a female coupling member.

In some embodiments, the extendable members are made up of at least two telescoping members, i.e., where one member (the interior member) fits inside of the other member (exterior member) and extends by way of a telescoping motion. In the preferred embodiments, the exterior is attached to the door side non-extendable member and the interior member is attached to the interior side non-extendable member; these relationships can optionally be reversed.

Each extendable member has a movement mechanism. In some embodiments, the movement mechanism is a ballscrew assembly composed of a motor, at least one ballscrew, and at least one ballnut. A ballscrew is a mechanical linear actuator that translates rotational motion to linear motion with little friction. A threaded shaft provides a helical raceway for a ballnut.

In the some embodiments, the ballnut is attached to a mounting bracket. The mounting bracket is also attached to only the exterior member of the telescoping extendable member.

The motor is positioned near one end of the ballscrew at either the door or interior side, preferably the interior side and functions to turn the ballscrew.

The ballscrew traverses the length of the base from the door side member to the interior side member or attachment point to the vehicle frame. The door side terminal end of the ballscrew is attached to the door side non-extendable member.

In some embodiments, when the motor turns the ballscrew, the ballnut moves linearly along the ballscrew. Because a mounting bracket connects the ballnut to the extendable member, when the ballnut moves along the ballscrew, the extendable member which is attached to the bracket also moves linearly.

In the preferred embodiments which employ a track mechanism, when the ballnut moves linearly along the ballscrew the tract guides the linear movement of the extendable member.

In the embodiments which employ telescoping extendable members, because the mounting bracket is only connected to the exterior member of the telescoping extendable member, the base is either extended or retracted when the ballnut moves linearly along the ballscrew.

In some embodiments, the extendable members are telescoping and employ a track mechanism. In such embodiments, both functions described above occur.

In the preferred embodiments, the extendable base also includes two base track members which extend across the gap between extendable members and are attached to both extendable members. One base track member is positioned on top of the door side non-extendable member or near the door side terminal end of the extendable member. The other base track member is positioned toward the interior where the distance between the two members is determined by the size of the wheelchair platform discussed below.

The base track members have tracks on the sides that face each other, i.e., the door side base track member has a track on the interior side and the interior side base track member has a track on the door side. The base track members act as compatible female coupling members to the track rollers of the wheelchair platform that act as male coupling members.

In the preferred embodiments, the tracks of the base track are generally flat from the front terminal end of the track to about the middle of the track. The track members have a relatively sharp incline followed by a relatively gradual decline beginning in about the middle of the track members and proceeding from the front side to the back side. This curve in the track acts to tilt the front of the wheelchair platform upward as the wheelchair platform moves in a backward direction and to level the wheelchair platform when moved to a completely forward position.

In some embodiments, each member is made of multiple smaller member section, however, for the purposes of this application the collection of smaller members that make up a front, back, door side, or interior side of the frame are considered together to be a member. In some embodiments, the members are straight. In some embodiments, the members are curved or are comprised of abrupt changes in direction. In some embodiments, the members are attached to each other at positions other than the terminal ends.

The wheelchair platform includes a platform frame and a platform.

The platform is a rigid surface, preferably made of metal, attached to the top side of the platform frame. In the preferred embodiments, the platform includes a wheelchair lock device. The wheelchair lock device is a device that allows for a wheelchair to be secured to the platform when the device is in use and released from the platform when desired by a user.

In the preferred embodiments, the wheelchair lock device is positioned so that the center of gravity of an attached wheelchair will be over the center of the wheelchair platform. In the some embodiments, the wheelchair lock device allows for the movement of the wheelchair in the backward direction when released.

In some embodiments, the platform has cutout portions on at least one of the front or back sides to allow for wheels which are attached to the platform frame.

In some embodiments, the platform includes a portion of its surface which is raised. This raised portion corresponds to the space needed for the movement mechanism discussed below. In some embodiments, the raised portion is closed on each end and may function as a housing for a movement mechanism.

The platform frame is a rigid structure, preferably made of metal. In the preferred embodiments, the platform frame is square or rectangular, however, the exact shape can be customized for any vehicle. In the preferred embodiments, the perimeter of the platform frame is made of 4 side members: a front member, a back member, a door side member and an interior side member. In the preferred embodiment each four members are attached to each other at the terminal ends of the member, preferably by welding or with nut and bolt fasteners. For example, the ends of the front member are attached to one end of each of the door side and interior side members and the ends of the back member is attached to the other ends of the door side and interior side members. In the preferred embodiments, the members are steel beams.

In some embodiments, each member is made of multiple smaller member section, however, for the purposes of this application the collection of smaller members that make up a front, back, door side, or interior side of the frame are considered together to be a member. In some embodiments, the members are straight. In some embodiments, the members are curved or are comprised of abrupt changes in direction. In some embodiments, the members are attached to each other at positions other than the terminal ends.

In the preferred embodiments, the platform frame also includes two primary reinforcing members and four secondary reinforcing members. Primary reinforcing members extend between side members while secondary members extend between a side member and a primary reinforcing member or between two primary reinforcing members. In some embodiments, the platform frame includes from 1-10 primary reinforcing members and from 1-20 secondary reinforcing members. In some embodiments, any number of primary or secondary reinforcing members may be used.

In the preferred embodiments, a movement mechanism is attached to the platform frame. In the preferred embodiments the movement mechanism is a linear movement mechanism. The movement mechanism may optionally be the same or different from the movement mechanism used for extending and retracting the extendable members of the base.

In some embodiments, the movement mechanism is centered between the door side member and the interior side member. In some embodiments, the movement mechanism is also positioned slightly above the plane of the platform frame. In some embodiments, the movement mechanism has a primary reinforcing member adjacent and slightly below it along each of its side.

In some embodiments, the movement mechanism is a ballscrew assembly composed of a motor, at least one ballnut, at least one ballscrew, at least one ballnut coupler, and a guide arm. A ballscrew is a mechanical linear actuator that translates rotational motion to linear motion with little friction. A threaded shaft provides a helical raceway for a ballnut.

The ballscrew traverses the length of the platform frame from the front side member to the back side member. The motor is positioned near one end of the ballscrew at either the front or back side of the platform frame.

When the motor turns the ballscrew, the ballnut and ballnut coupler move linearly along the ballscrew. The guide arm attached both to the platform frame (preferably the side opposite the motor) and to the frame of the base. The guide arm is preferably attached by welding or fasteners. The guide arm also has a threaded portion that interacts with the ballscrew. Because the guide arm is attached to both the base and platform frame, the turning of the ballscrew by the motor results in the frontward or backward movement of the wheelchair platform relative to the extendable base.

In the preferred embodiments, the back side member includes at least one wheel that functions to contact the ground so as to protect the back member from scraping the ground when the wheelchair platform is unloading.

In the preferred embodiments, the wheelchair platform is attached to the base by way of the track mechanism. In the preferred embodiment, the wheelchair platform is attached to track mechanism by way of at least two track rollers. In the preferred embodiment, track rollers are wheels or bearings that are attached to and extend from the door side member and the interior side member. The track rollers act as a male coupling member to the track member of the base which acts as a compatible female coupling member. When the wheelchair platform is moved by the movement mechanism, the track rollers follow the tract member of the base to guide the movement of the wheelchair platform.

In some embodiments, the door of the vehicle or multiple doors on the same side of the vehicle are attached to the door side non-extendable member and extend away from the vehicle when the extendable members are extended.

In some embodiments, the wheelchair lift additionally includes a door modification kit comprising a join plate, a door structure replacement, and an upper door join plate. The join plate functions to join the doors forward and reward doors on a single side of a vehicle together. In the preferred embodiment, the join plate is positioned at the base of the doors and is oriented horizontally. The door structure replacement functions to replace the area which is normally between forward and reward doors. In the preferred embodiment, the door structure replacement is oriented vertically. The upper door join plate is similar to the join plate however, the upper door join plate is positioned above the windows of the vehicle.

### BRIEF DESCRIPTION OF THE DRAWINGS

FIG. 1 is a perspective view of the primary frame.

FIG. 2 is another perspective view of the primary frame.

FIG. 3 is a perspective view of the primary frame on a mounting device.

FIG. 4 is another perspective view of the primary frame on a mounting device

FIG. 5 is a perspective view of the primary frame being mounted to a vehicle frame.

FIG. 6 is a bottom view of the primary frame mounted to a vehicle frame.

FIG. 7 is a perspective view of the extendable frame.

FIG. 8 is a bottom perspective view of the wheelchair platform frame.

FIG. 9 is a top view of the wheelchair platform.

FIG. 10 is an example of a vehicle door that has been modified to be compatible with the wheelchair lift apparatus.

FIG. 11 illustrates the unloading movement of the wheelchair lift apparatus.

FIG. 12 illustrates the final unloading step where the wheelchair is released from the device.

FIG. 13 is an example of modifications made to a vehicle frame to be compatible with the wheelchair lift apparatus.

FIG. 14 is another example of modifications made to a vehicle frame to be compatible with the wheelchair lift apparatus

FIG. 15 is a perspective view of a preferred embodiment showing the apparatus in a retracted position.

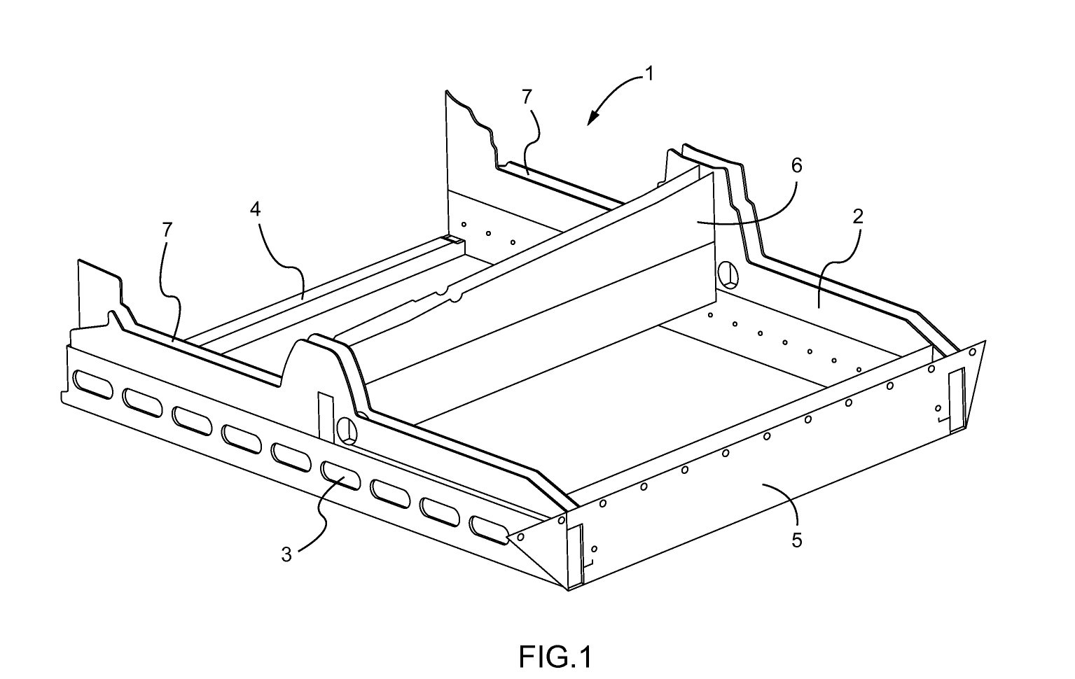

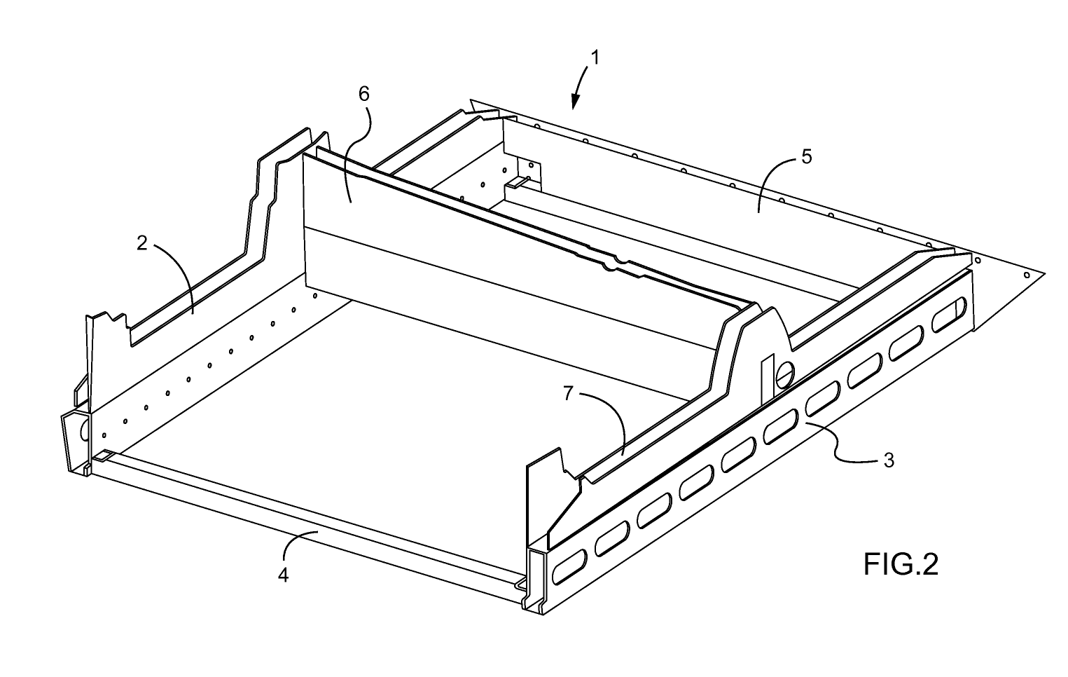

FIGS. 1-2 shows a perspective view of the primary frame (1). In the preferred embodiments the primary frame includes a front side (2) member, a back side member (3), a door side member (4), and an interior side member (5). In the preferred embodiments, the primary frame includes a center member (6) that is positioned between the door side (4) and interior side (5) members and attached to the front side (2) and back side (3) members and optionally to a vehicle frame. In the preferred embodiments, the front side (2) and back side (3) members include track members (7) which function as compatible female coupling members to wheels or bearings (9) of the extendable base (8) that function as compatible male coupling members.

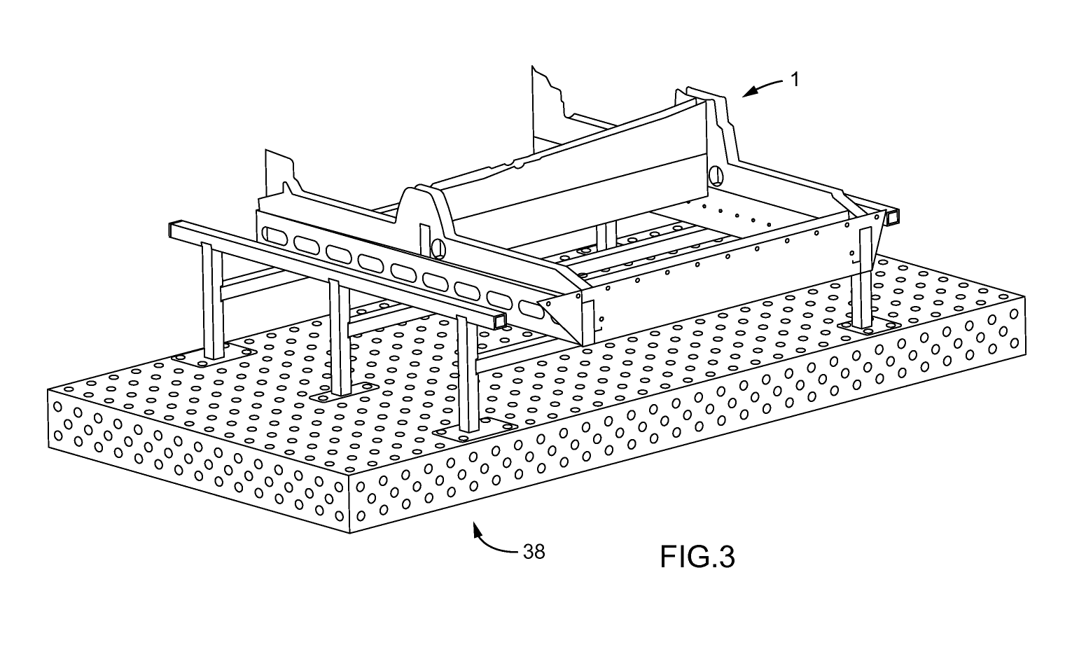

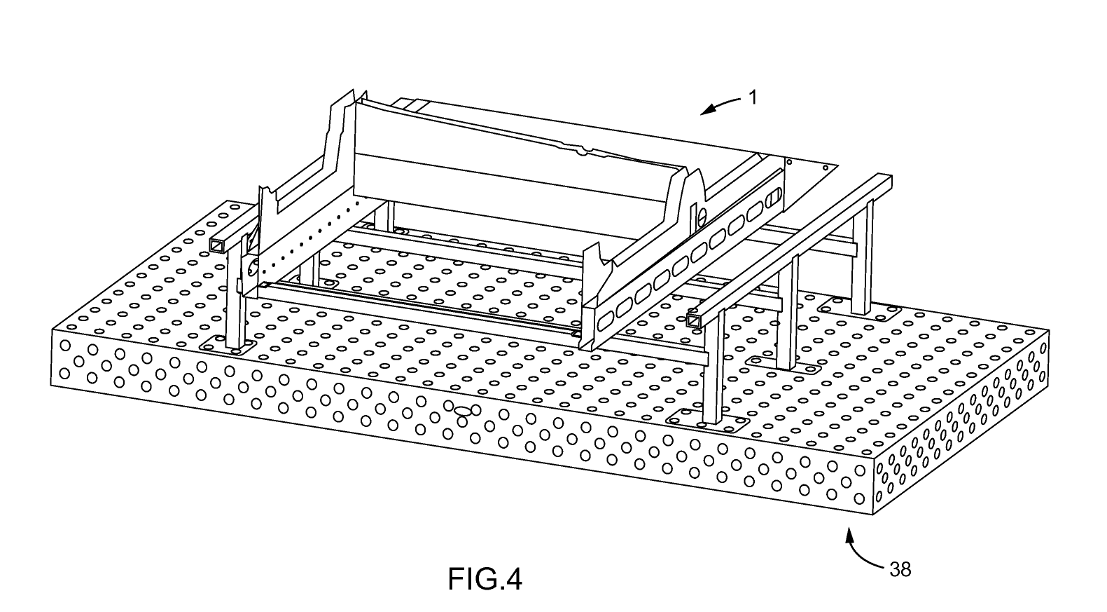

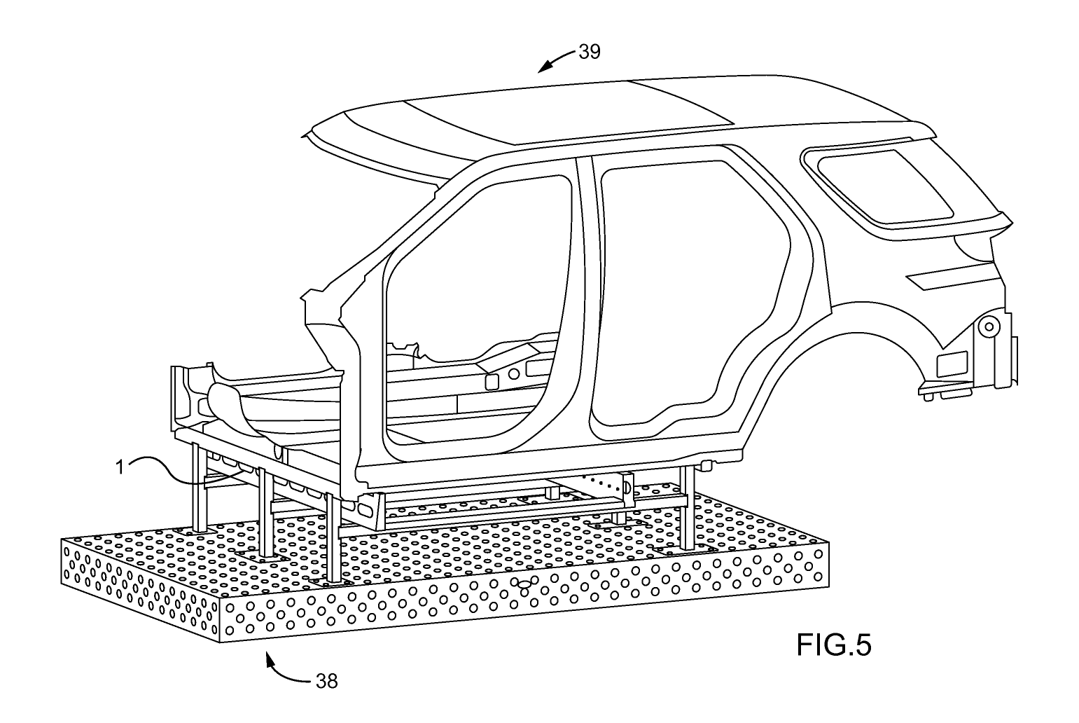

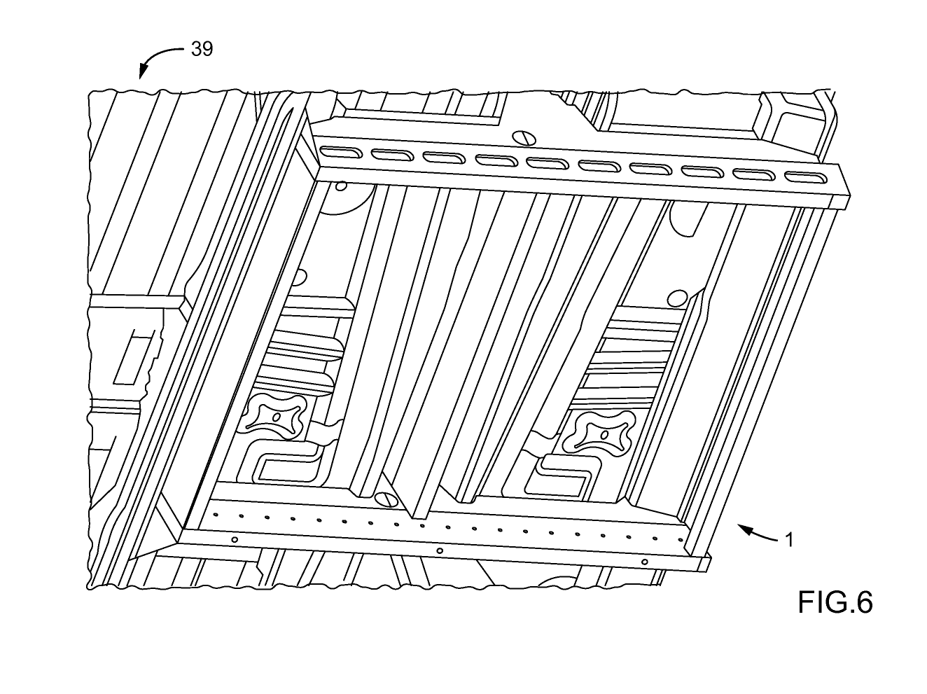

FIGS. 3-4 show the primary frame (1) on a mounting assembly (38) and FIGS. 5-6 show the primary frame (1) being attached to a vehicle (39).

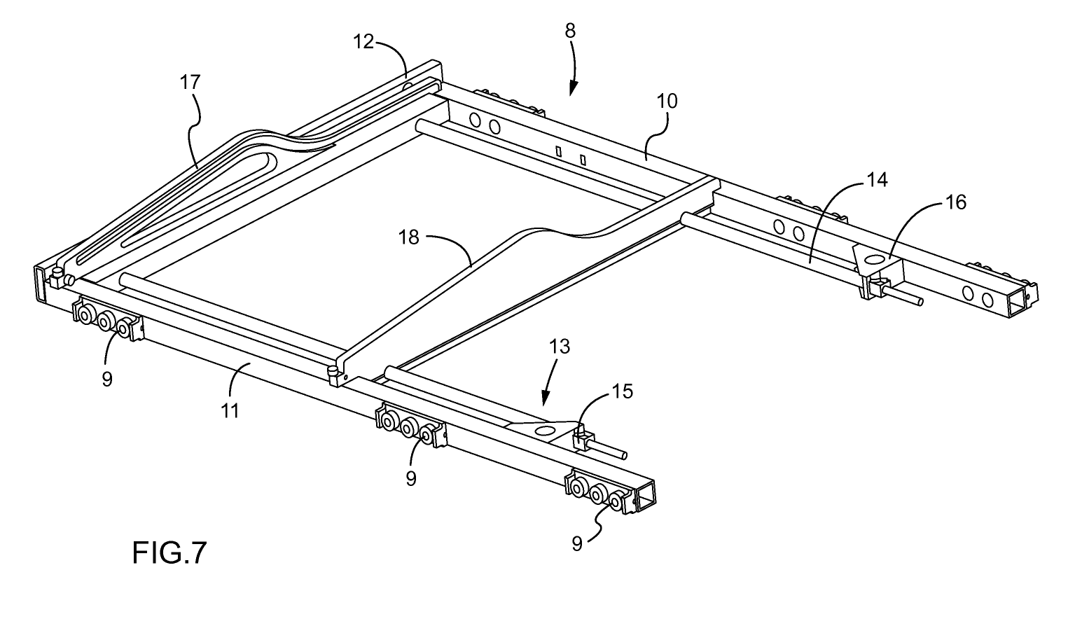

FIG. 7 shows the extendable base (8) which includes at least one extendable front side member (10) and at least one extendable backside member (11). The extendable base (8) also includes a non-extendable door side member (12) which is attached at its terminal ends or optionally near its terminal ends to the door side terminal ends, or optionally near the door side terminal ends of the extendable members (10 and 11). Each extendable member has a movement mechanism (13). In some embodiments, the movement mechanism (13) is a ballscrew assembly composed of a motor (45), at least one ballscrew (14), and at least one ballnut (15). In the some embodiments, the ballnut is attached to a mounting bracket (16). In the preferred embodiments, the extendable base also includes two base track members, a door side member (17) and an interior side member (18). The track members extend across the gap between extendable members (10 and 11) and are attached to both extendable members (10 and 11).

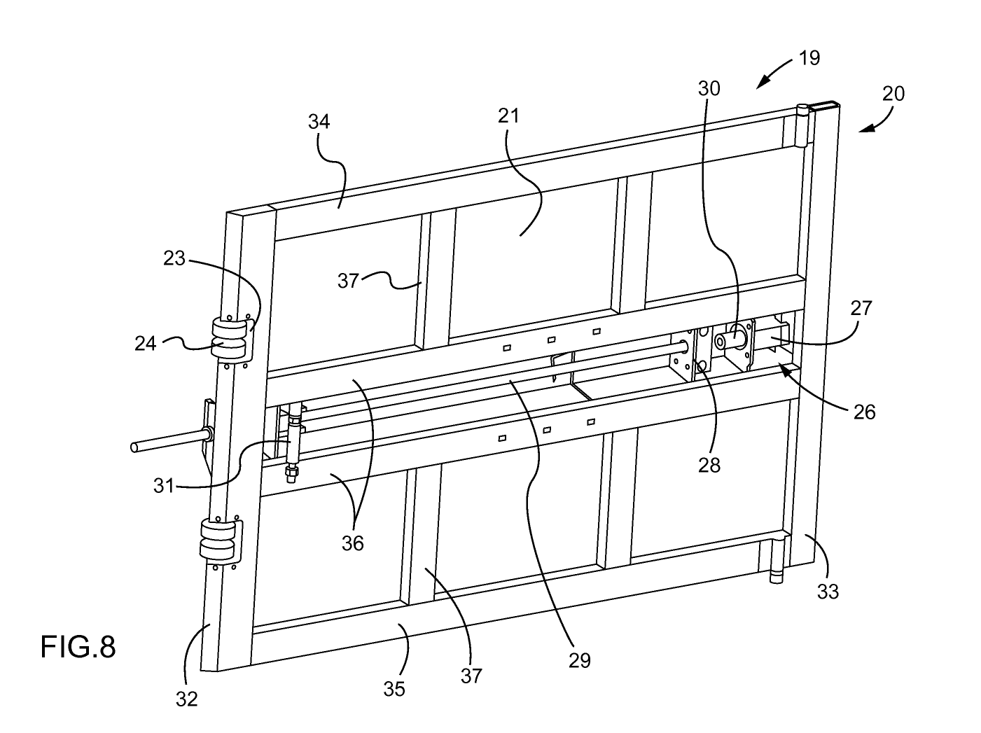

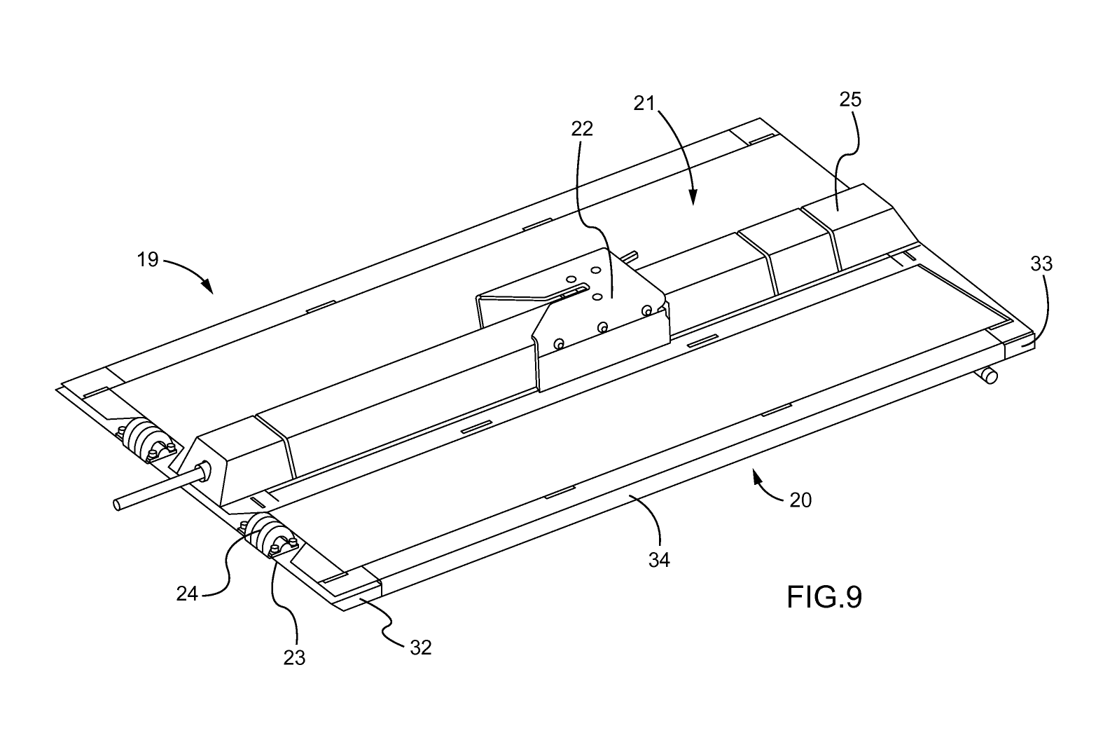

FIGS. 8 and 9 show the wheelchair platform (19) which includes a platform frame (20) and a platform (21). In the preferred embodiments, the platform includes a wheelchair lock device (22). In some embodiments, the platform (21) has cutout portions (23) on at least one of the front or back sides to allow for wheels (24) which are attached to the platform frame (20). In some embodiments, the platform (21) includes a raised portion (25) which is a portion of the platform's (21) surface which is raised. This raised portion corresponds to the space needed for the movement mechanism (26). In some embodiments, the movement mechanism is a ballscrew assembly composed of a motor (27), at least one ballnut (28), at least one ballscrew (29), at least one ballnut coupler (30), and a guide arm (31).

In the preferred embodiments, the perimeter of the platform frame (20) is made of 4 side members: a front member (32), a back member (33), a door side member (34) and an interior side member (35). In the preferred embodiments, the platform frame (20) also includes two primary reinforcing members (36) and four secondary reinforcing members (37).

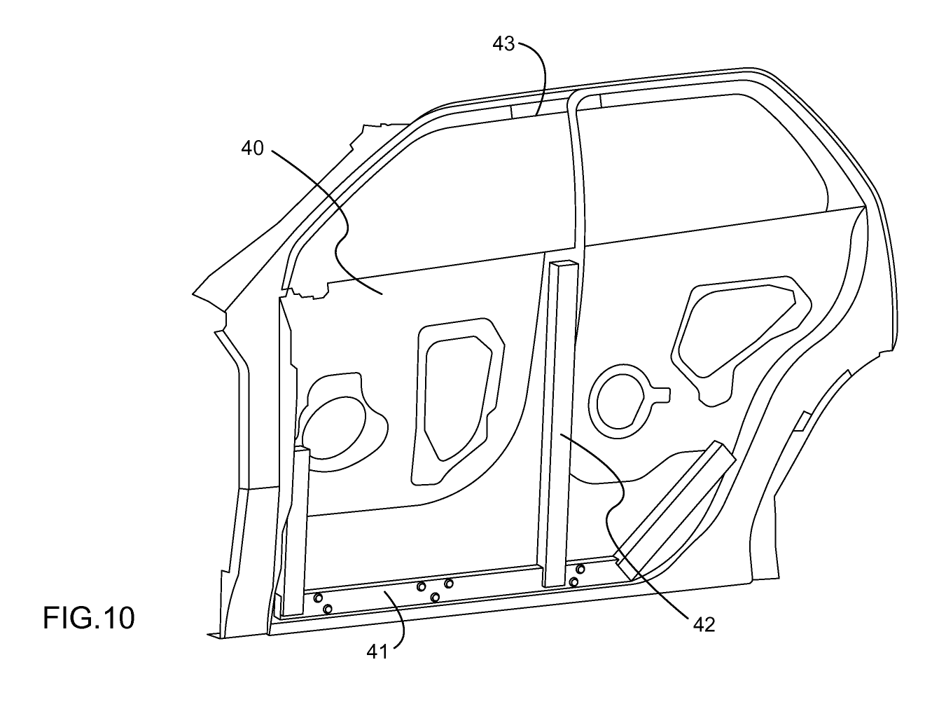

FIG. 10 shows an embodiment where the door of a vehicle (40) is modified so as to be suitable for adapting a wheelchair lift to a vehicle. The door (40) is modified to include a join plate (41), a door structure replacement (42), and an upper door join plate (43). In some embodiments, these modification effectively transform the front and back doors of a vehicle into a single structure.

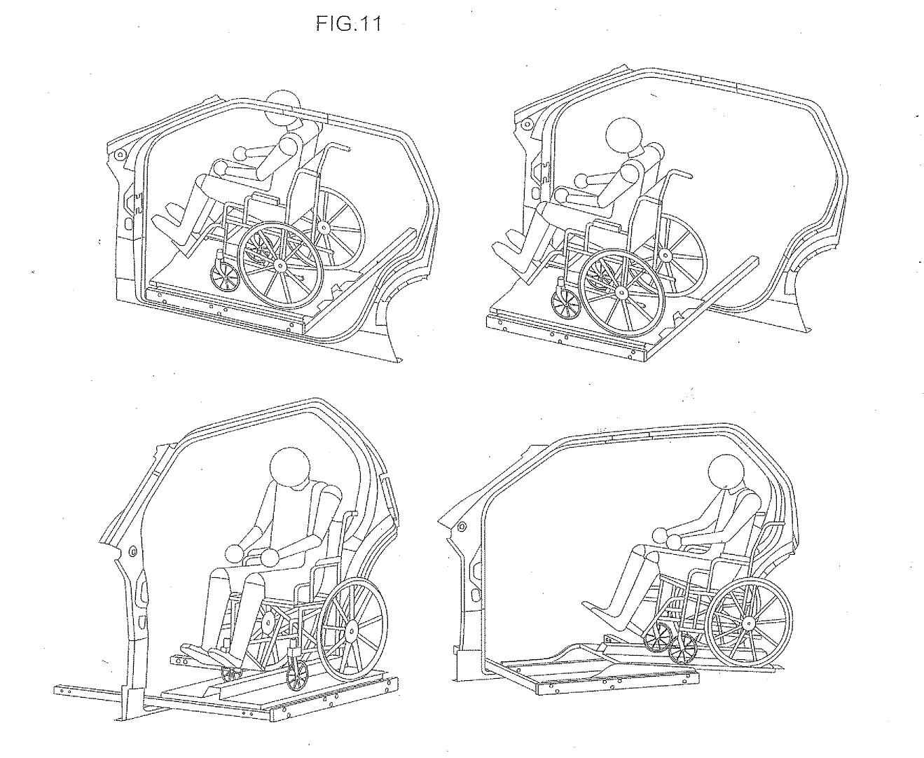

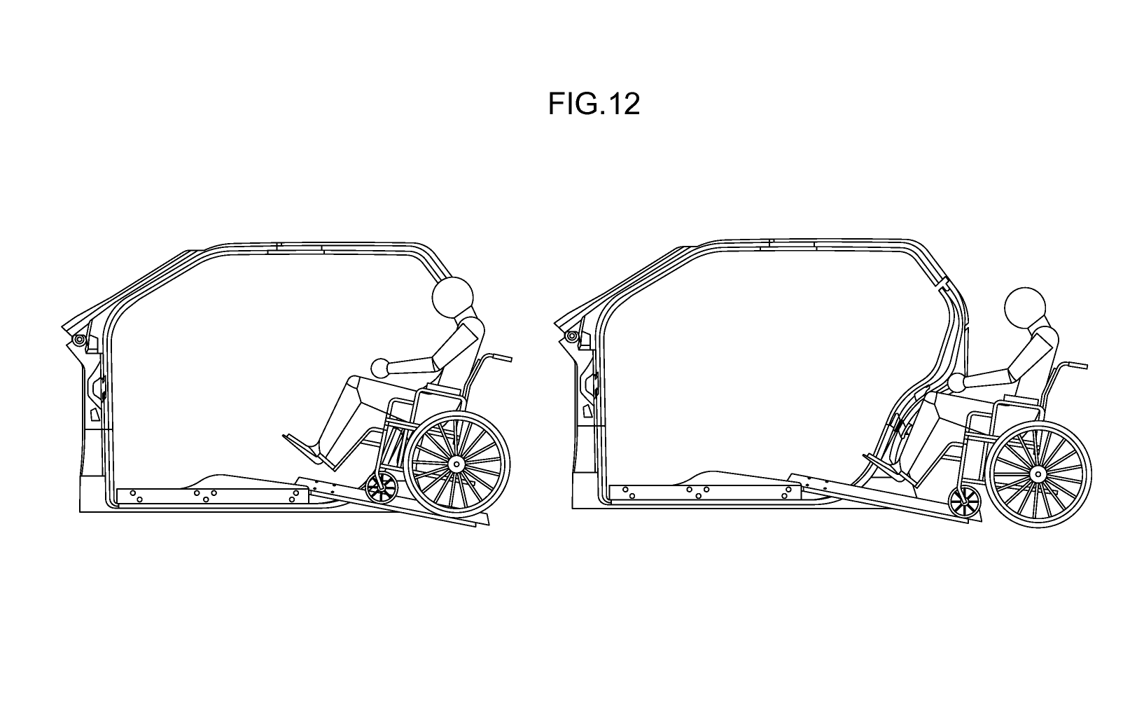

FIG. 11 shows the movement of the wheelchair lift device, in four stages, from a position in which a vehicle can be operated to a position which a wheel chair can roll onto the ground. FIG. 12 shows a more detailed view of the wheelchair rolling off of the wheelchair lift device and onto the ground.

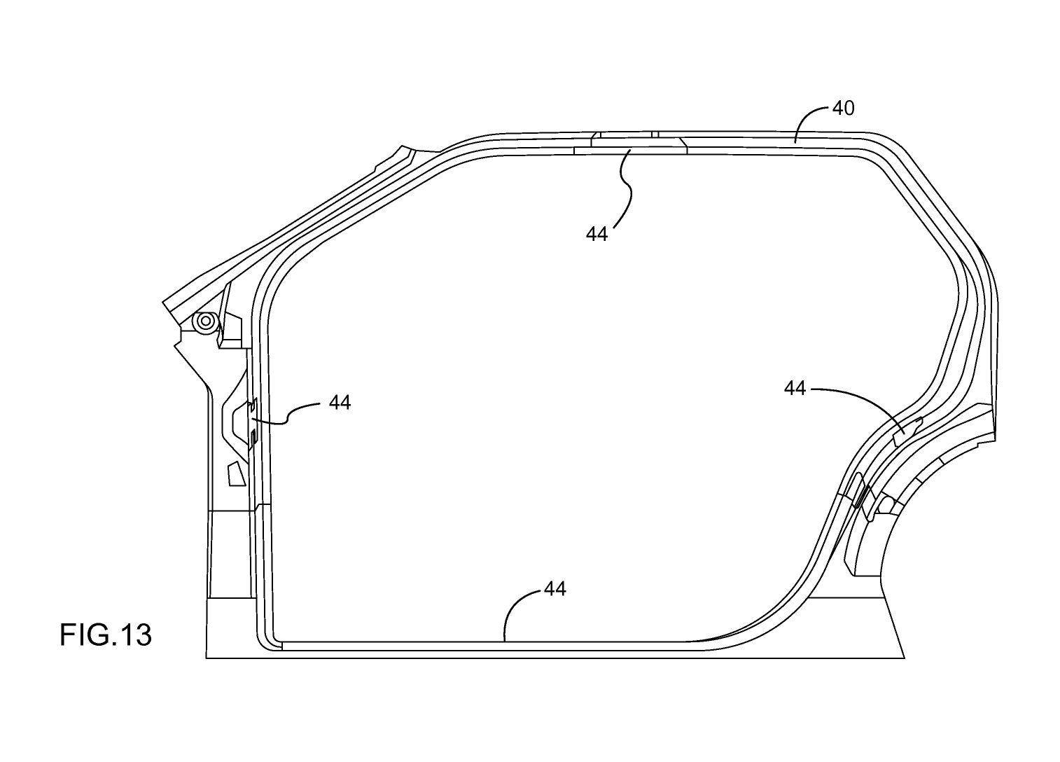

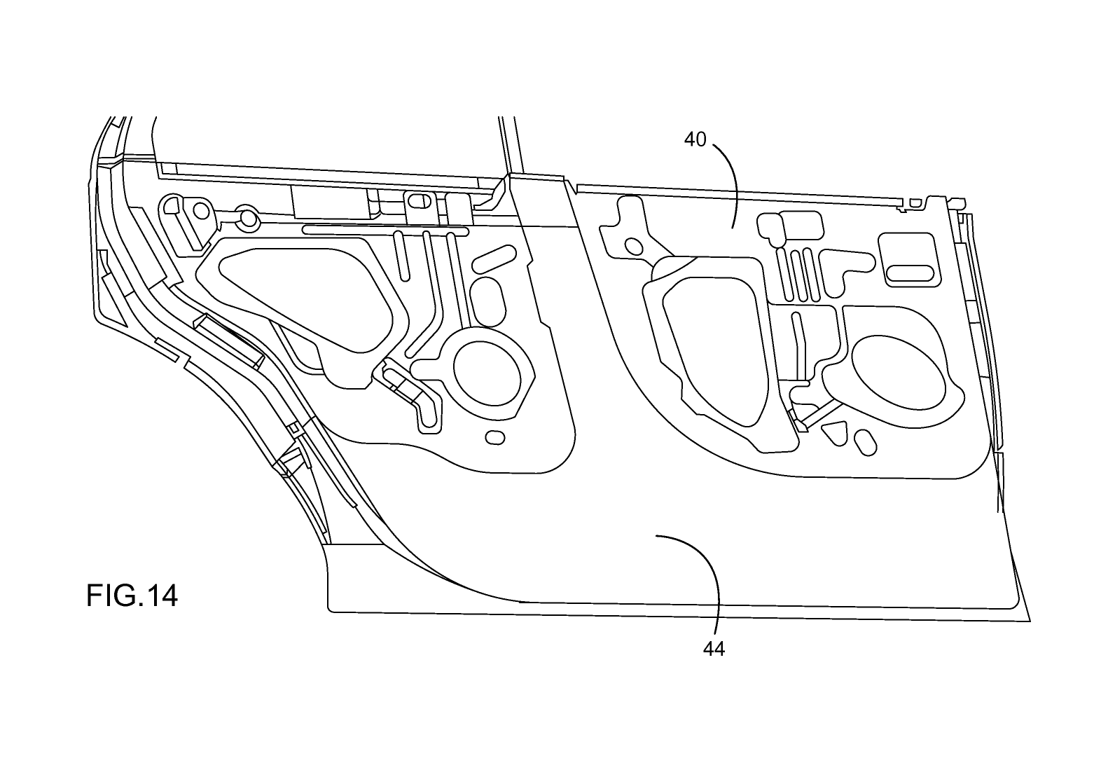

FIGS. 13 and 14 show regions (44) of a vehicle door (40) that are modified in some embodiments to so as to be suitable for adapting a wheelchair lift to a vehicle.

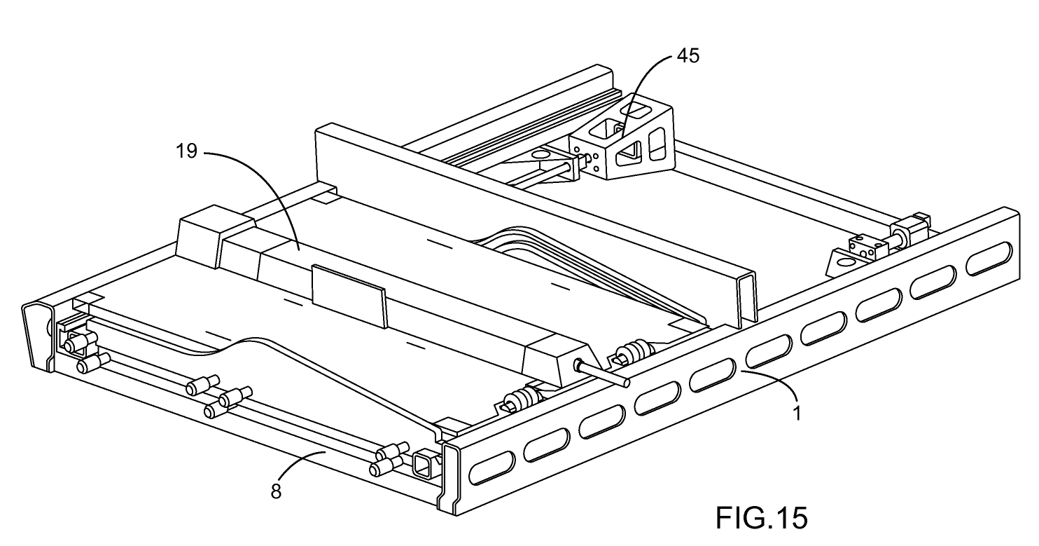

FIG. 15 shows a fully assembled wheelchair lift device. The wheelchair platform (19) is positioned on top of the extendable base (8) which is positioned on top of the primary frame (1). FIG. 15 also show motor (45) which powers movement mechanism (13) of the primary frame (1) which functions to extend the extendable base (8) from the vehicle body.

1. A wheelchair lift apparatus for a vehicle comprising:
A. a primary frame, wherein the primary frame is comprised of at least a primary frame front side member and a primary frame back side member that are attached to a vehicle frame wherein said front and back side members include a primary frame track member which are positioned to face each other;
B. an extendable base, wherein the extendable base is comprised of an at least an extendable front member, an extendable back member, and a non-extendable door side member which is attached to said front and back extendable members,
wherein the extendable members include wheels or bearings attached to the extendable base front side and extendable base back side members which are compatible with the primary frame track members and are suitable to attach the extendable base to the primary frame through the interaction of the wheels or bearings with the primary frame track members,
wherein the extendable base additionally includes at least one extendable base door side base track member and an extendable base interior base side track member which are attached to both extendable members, and
wherein the base track members have tracts that are positioned to face each other; and
C. a wheelchair platform wherein the wheelchair platform is comprised of a platform frame and a platform,
wherein the platform frame is comprised of at least one platform frame front side member, at least one platform frame back side member, at least one platform frame door side member and at least platform frame one interior side member, and
wherein the wheelchair platform includes platform track rollers attached to exterior sides of the platform frame door side and platform frame interior side members which are compatible with the extendable base track members and are suitable to attach the wheelchair platform to the extendable base through the interaction of platform track rollers with the extendable base track members.

2. The wheelchair lift apparatus of claim 1 wherein the primary frame has a center member.

3. The wheelchair lift apparatus of claim 1 wherein the extendable base and wheelchair platform have a movement mechanism.

4. The wheelchair lift apparatus of claim 3 wherein the movement mechanism of the extendable base is powered by a motor attached to an interior side member of the primary frame and the movement mechanism of the wheelchair platform is powered by a motor attached to the wheelchair platform and acts to move the wheelchair platform through interaction with a guide arm.

5. The wheelchair lift apparatus of claim 1 wherein the wheelchair platform includes at least one primary reinforcing member and at least one secondary reinforcing member.

6. The wheelchair lift apparatus of claim 1 wherein the wheelchair platform includes wheels attached to the platform frame back side member which contact the ground when in a fully off-loading position.

7. The wheelchair lift apparatus of claim 1 wherein the extendable base additionally includes a non-extendable interior side member which is attached to said extendable members.

8. The wheelchair lift apparatus of claim 1 wherein the extendable members of the extendable base are telescoping.

9. The wheelchair lift apparatus of claim 4 wherein the movement mechanism is comprised of a ballscrew assembly which is comprised of a motor, at least one ballscrew, and at least one ballnut.

10. The wheelchair lift apparatus of claim 1 wherein a vehicle door is attached to the extendable base door side member.

11. The wheelchair lift apparatus of claim 1 wherein the extendable base door side base track member and the extendable base interior base side track member are attached to said extendable members.

12. The wheelchair lift apparatus of claim 1 further comprising a door modification kit comprising a, join plate, a door structure replacement, and an upper door join plate.

13. The wheelchair lift apparatus of claim 1 wherein the platform is comprised of a rigid surface which is attached to the top of the platform frame and a wheelchair lock which is capable of selectively locking and releasing a wheelchair to the wheelchair platform.
